(19) United States
(12) Patent Application Publication
(10) Pub. No.: US 2022/0348510 A1
(43) Pub. Date: Nov. 3, 2022

(54) Method for preparing gel composite material with piezoelectric property, and gel composite material and use thereof

(71) Applicant: Anhui University of Technology, Ma'anshan City (CN)

(72) Inventors: Huihong Lv, Ma'anshan City (CN); Yilong Ji, Ma'anshan City (CN); Bing Dai, Ma'anshan City (CN); Xianfeng Yang, Ma'anshan City (CN); Zhao Lei, Ma'anshan City (CN); Xingrong Wu, Ma'anshan City (CN); Liaosha Li, Ma'anshan City (CN)

(21) Appl. No.: 17/733,005

(22) Filed: Apr. 29, 2022

(30) Foreign Application Priority Data
Apr. 29, 2021 (CN) 202110471834.0

(51) Int. Cl. C04B 40/02; C04B 18/14; C04B 22/06

(52) U.S. Cl. CPC C04B 40/0263; C04B 18/144; C04B 22/06; C04B 2111/00215

(57) ABSTRACT

Provided are a method for preparing a gel composite material with a piezoelectric property, and the gel composite material and use thereof, which belongs to the field of intelligent road traffic. In the method, titanium-containing blast furnace slag and metal oxides (PbO and ZrO₂) are sufficiently and uniformly mixed, an obtained mixture is calcined under a certain thermal system, on the theoretical basis of mineral-phase reconstruction-synergistic regulation of all valuable components, and the mixture is cooled to a room temperature with a furnace to obtain the gel composite material with a piezoelectric property.

### CROSS REFERENCE TO RELATED APPLICATION

The present disclosure belongs to the technical field of use of blast furnace slag and particularly relates to a one-step method for preparing a piezoelectric gel composite material by using a titanium-containing blast furnace slag as a raw material.

### BACKGROUND OF THE INVENTION

The Ministry of Natural Resources is established in 2018. Reform of implementing a mineral resource management system is promoted, strategic asset investigation and evaluation are continuously enhanced, and a comprehensive development and utilization level is continuously improved. Based on relevant regulations of green mine construction, mineral survey and evaluation, mineral resource planning, mineral resource supervision and management and the like, mineral resource exploration, development and utilization are conducted, an energy consumption structure is optimized, ecological protection and restoration are conducted, and thus comprehensive development and utilization of mineral resources and mine geological environment protection are actively promoted.

Accumulation and highly-added-value utilization of a titanium-containing blast furnace slag is a key problem in the metallurgical industry. Great results are achieved after generations of hard work. However, large-scale, highly-added-value and market-economic utilization of the titanium-containing blast furnace slag is still difficult. There is a need for interdisciplinary and diversified exploitation of resources optimization based on different resource characteristics of different types of solid wastes.

A method for preparing a piezoelectric concrete material by using a titanium-containing blast furnace slag as a raw material with a patent application No. 201910208190.9 was disclosed on Jun. 21, 2019. In the patent, the titanium-containing blast furnace slag and a transition metal oxide or a rare earth oxide were mixed uniformly and heated to be molten, uniform mixing was ensured, an in-situ optimized titanium-containing blast furnace slag was obtained after cooling to a room temperature, the in-situ optimized titanium-containing blast furnace slag was mixed uniformly with sodium carbonate or sodium bicarbonate to conduct a mineral-phase reconstruction, and a reconstructed titanium-containing blast furnace slag was the piezoelectric concrete material. However, the piezoelectric concrete material in this study required an additional gel material

The present disclosure specifically provides components of a piezoelectric phase and a gel phase and a forming mechanism, which has different raw materials and roasting system with the above patent. In the present disclosure, a piezoelectric gel material can be blended into cement concrete, that is, can be used as a supplement of a gel active component, and can also be used correspondingly in the field of intelligent road traffic, such as structural health monitoring (SHM) and the like.

A PZT type sensor inherits advantages of PZT ceramic, has a high Curie temperature and a high piezoelectric coefficient, can stand harsh external environment, has advantages of a high response speed, a wide response frequency and the like, and has a great use space in the fields of cement concrete, SHM, intelligent roads and the like.

Through searching, it was found that Li Shuang, Zhang Lin, Fu Cheng Wei, et al. disclosed “high-pressure synthesis of PbZr_{0.52}Ti_{0.48}O₃” in page 520-523, 46(3) of Journal of Jilin University (Science Edition) on May 26, 2008. In the study, 2 raw materials were used for high-pressure synthesis of PbZr_{0.52}Ti_{0.48}O₃. Experimental results showed that PbO, ZrO₂ and TiO₂ (1:0.52:0.48) were used as raw materials, a three-phase mixture of PbTiO₃, ZrO₂ and Pb was mainly formed under 1.5 GPa and 3.6 GPa at 880-1,061° C., and only a small amount of lead zirconate titanate (PZT) phase was generated near 880° C. Zr_{0.52}Ti_{0.48}O₂ was used as a B-site precursor and mixed with PbO for high-pressure high-temperature synthesis to form a PbZr_{0.52}Ti_{0.48}O₃ phase under 1.5 GPa at 710-812° C., and a PbTiO₃ phase was not found. Temperature-variable Raman measurement was conducted on a PbZr_{0.52}Ti_{0.48}O³ sample synthesized at a high pressure and a high temperature (1.5 GPa and 812° C.) and a structural phase change did not occur at 245° C.; and at 420° C., a Raman spectrum only had three peaks of 177.5, 257.7 and 517 cm⁻¹, and a structure was changed from a ferroelectric phase to a cubic paraelectric phase, such that the PbZr_{0.52}Ti_{0.48}O₃ synthesized at a high pressure had a Curie temperature below 420° C.

Li Shuang in Jilin University disclosed “synthesis and performances of ferroelectric material lead zirconate titanate (PZT)” on Jun. 1, 2004. A synthesis method of the PZT was as follows: a stoichiometric proportion of the raw materials was used according to the following chemical equation: PbO+0.52ZrO₂+0.48TiO₂=PbZr_{0.52}Ti_{0.48}O₃, where the PbO was excessive and 5% of the total weight to prevent volatilization. Prepared raw materials were put into an agate mortar, a certain amount of alcohol was added, the raw materials were fully ground, and the ground sample was dried in an oven. The uniformly mixed raw materials were pre-calcined, heat preservation was conducted at 650° C. for 1 h, respective heating was conducted to a pre-calcining temperature of (800° C., 850° C., 900° C. and 1,000° C.) and heat preservation was conducted for 2.5 h. All the powder samples after the pre-calcining changed from orange to light yellow. After cooling, the powder samples were pressed into a sheet sample with a diameter of 13 mm under a pressure of 200 MPa. The sheet sample was calcined at 1,200° C. at a heating rate of 3° C./min, heat preservation was conducted for 4 h, and cooling was conducted to a room temperature.

Conventional ferroelectric material lead zirconate titanate preparation methods were disclosed in the two references, the raw materials were experimental pure reagents, reactants were easy to control, but a titanium slag system was complex and diversified, the reaction was difficult to regulate and control, only a piezoelectric functional phase can be obtained, and a one-step synthesis of a piezoelectric gel cannot be realized.

Under external static/dynamic load, an embedded sensor can be used for keeping integrity of a concrete structure and make quick and high-precision response to a surrounding stress change, strain and the like. A nondestructive monitoring technology is established in a bonding or embedding matrix structure, a structure is monitored through changes such as electrical impedance, and piezoelectric ceramics are used as an actuator and a sensor.

Therefore, in the prior art, a pure piezoelectric PZT sensor is generally embedded in concrete, but a mechanical impedance response obtained by the piezoelectric sensor may be incompatible with the concrete, and the pure piezoelectric PZT sensor has poor ductility and not high density, and cannot stably work in an environment with complex environment and inconsistent load pressure changes for a long time. In order to solve a problem that the piezoelectric sensor does not have good compatibility with structural materials, such as difference in acoustic impedance, temperature coefficients, shrinkage characteristics, and the like, the titanium-containing blast furnace slag is used as a titanium source to construct a PZT functional phase, and can be used as a gel active component of cement concrete and a functional material in SHM, intelligent road sensing and the like. However, related research is still blank.

Since the 80s of the last century, a series of experiments have been developed on how to efficiently and greenly utilize vanadium titano-magnetite and utilization of the titanium-containing blast furnace slag have troubled us for decades. Highly-added-value utilization of titanium extraction in the field of building materials, such as preparation of a high-titanium type composite admixture, hollow brick and the like, is explored. Pangang autonomously designed and established a pilot scale test line of “10 kt/a of refined TiCl₄ through high-temperature selective carbonization and low-temperature selective chlorination”. A high-temperature carbonization-selective separation, an alkali treatment phase separation titanium extraction technology and an alloying extraction were established on the basis. The utilization of the titanium-containing blast furnace slag has been researched for decades. Although a certain success has been achieved, the true highly-added-value industrial utilization still needs extensive scientific researchers to continuously explore and strengthen.

Therefore, there is a need to find a piezoelectric gel composite material prepared from a titanium-containing blast furnace slag as a raw material, which achieves a purpose of recycling the titanium-containing blast furnace slag, and to obtain a piezoelectric gel material which can be directly blended into cement concrete.

### SUMMARY OF THE INVENTION

### 1. Problem to be Solved

The present disclosure aims to provide a one-step method for preparing a gel composite material with a piezoelectric property by using a titanium-containing blast furnace slag as a main raw material. The method has a potential of large-amount consumption and highly-added-value utilization of the titanium-containing blast furnace slag. Lead and zirconium oxides are used for mineral-phase reconstruction and modification on titanium-containing diopside, perovskite and the like in the titanium-containing blast furnace slag, the lead and zirconium oxides replace TiO₂ in the diopside phase, the TiO₂ is combined with the lead oxide and further reacts with PbZrO₃ to generate a PZT phase, the perovskite and the PbZrO₃ react in situ to generate PbTiO₃, and the decomposition of the perovskite generates a feldspar phase, namely a main source of a gelling activity.

The gel composite material can be used in cement concrete and nondestructive real-time health monitoring of buildings, roads and bridge structures.

### 2. Technical Solution

To solve the above problem, the present disclosure adopts the following technical solution:

A method for preparing a gel composite material with a piezoelectric property by using a titanium-containing blast furnace slag specifically includes the following steps:

(1) crushing: crushing and grinding a titanium-containing blast furnace slag to powder with a basically same particle size;

(2) uniform mixing: uniformly mixing the powdery titanium-containing blast furnace slag obtained in step (1) with lead and zirconium oxides to obtain a multi-component system mixture; and the metal oxides are derived from a metal raw ore and slag and other metal-containing substances; and

(3) modification and reconstruction: wherein the modification and reconstruction has three stages and the three stages maximize the content of a required PZT phase through a thermal system;

in the first stage, heat preservation is conducted at 600° C-768.8° C. for 0.5-1.5 h and reaction is as follows:

PbO+ZrO₂=PbZrO₃ Formula (a);

at the same time, when heating is conducted to a low temperature in the first stage, volatile substances such as bound water can also be removed;

in the second stage, heating is accelerated to 800-910° C., heat preservation is conducted for 1.5-2.5 h and reaction is as follows:

PbZrO₃+CaTiO₃=CaZrO₃+PbTiO₃ Formula (b);

in order to force Ca at an A site of perovskite to migrate from the perovskite to silicate, in the second stage, when a calcining temperature is raised to above 800° C., reaction is as follows:

PbZrO₃+CaTiO₃+CaMgSi₂O₆=PbTiO₃+Ca₂MgSi₂O₇+ZrO₂ Formula (c);

and

in the third stage, cooling is conducted to 700° C.-768° C., heat preservation is conducted for 1.0-2.5 h, cooling is conducted to a room temperature with a furnace, the regenerated ZrO₂ in reaction formula (c) reacts with excess PbO to generate PbZrO₃ during the cooling process, the PbZrO₃ and PbTiO₃ forms a binary continuous PZT phase, that is, a piezoelectric phase, the Ca₂MgSi₂O₇ generated in reaction formula (c) is a gel phase, whose gelling activity comes from a feldspar phase, and a gel composite material containing a piezoelectric phase and a gel phase is obtained;

wherein, the piezoelectric phase (PZT phase) mainly derived from PbZrₓTi₁₋ₓO₃ (0<x<1), and the gel phase is Ca₂MgSi₂O₇.

Further, in step (2), Pb, Zr and Ti in the multi-component system mixture have a molar ratio of 1.1:0.52:0.48; and the multi-component system mixture has a stoichiometric ratio according to the chemical formula:

PbO+0.52ZrO₂+0.48TiO₂=PbZr_{0.52}Ti_{0.48}O₃, and

since lead oxide is volatile, such that a slight excess of the lead oxide needs to be added and the selected raw materials Pb, Zr and Ti have a molar ratio of 1.1:0.52:0.48.

Further, in step (2), the lead and zirconium oxides are PbO and ZrO₂ separately.

Further, TiO₂ in the titanium-containing blast furnace slag has a mass percentage of larger than 20%, the titanium-containing blast furnace slag is used as a titanium source, PbO is uniformly distributed in a titanium slag system, and titanium slag powder avoids volatilization of the PbO to a certain extent.

Further, in step (3), in a first stage, heat preservation is conducted at 700° C. for 1 h, in a second stage, heating is accelerated to 800° C.-910° C. and heat preservation is conducted for 2 h, in a third stage, cooling is conducted to 750° C. and heat preservation is conducted for 2 h, and cooling is conducted to a room temperature with a furnace to obtain a mineral-phase reconstructed and modified composite material, that is, a gel composite material containing a piezoelectric phase and a gel phase.

Further, it should be noted that when a temperature is higher than 768.8° C., PbZrO₃ is unstable and easily decomposed into PbO and ZrO₂. In order to ensure an effective progress of the reaction in formula (c), the calcination should be conducted at a higher heating rate to 768.8-831.5° C., such that a heating rate of the second stage is ≥10° C./min.

Further, a heating rate of the first stage is 5-10° C./min and a cooling rate of the third stage is 5-10° C./min

A gel composite material with a piezoelectric property is obtained by the method and contains a piezoelectric phase and a gel phase, wherein the piezoelectric phase is PbZrₓTi₁₋ₓO₃ (0<x<1) and accounts for 50-60% of a total mass of a system, the gel phase is Ca₂MgSi₂O₇ and accounts for 8-15% of the total mass of the system, and the other is a silicate that does not have a gel property.

In one embodiment of the present disclosure, the preparation method is not limited, the gel composite material with a piezoelectric property contains a piezoelectric phase and a gel phase, the piezoelectric phase is PbZrₓTi₁₋ₓO₃ (0<x<1) and accounts for 50-60% of a total mass of a system, and the gel phase is Ca₂MgSi₂O₇ and accounts for 8-15% of the total mass of the system.

A main principle of a modification and reconstruction process of the titanium-containing blast furnace slag of the present disclosure is as follows: in the first stage (heating stage), mixed powder is heated to a low temperature to remove volatile substances such as bound water, and heat preservation is conducted at 700° C. for 1 h, which is beneficial to generate PbZrO₃; in the stage of heating to a high temperature and conducting heat preservation and mineral-phase reconstruction, that is, the second stage, heating is conducted to 800-910° C. at a heating rate of 10° C./min, heat preservation is conducted for 2 h, such that the PbZrO₃ continuously generates; in the third stage, cooling to a certain temperature with a furnace is conducted to promote homogenized generation of a functional phase, heat preservation is conducted at 750° C. for 2 h, the regenerated ZrO₂ reacts with PbO to generate PbZrO₃, which promotes a homogenized change of the functional phase; and cooling is conducted to a room temperature with the furnace and a powder with a piezoelectric phase and a gel phase is obtained.

The gel composite material with a piezoelectric property is used in cement concrete.

The gel composite material with a piezoelectric property is used in non-destructive real-time health monitoring of buildings, roads and bridge structures.

### 3. Beneficial Effects

Compared with the prior art, the present disclosure has the following beneficial effects:

(1) The composite material prepared by the method of the present disclosure has a best piezoelectric coefficient of 6.0 pC/N at a polarization voltage of 55 kV/cm and polarization time of 20 min, and a gel active component accounts for 11.5% of a mass percentage of the system; free TiO₂ is enriched in a PZT phase, thus “Ti” is dispersed and distributed to a piezoelectric functional phase from diopside and perovskite, and generation of the gel active component is promoted. The present disclosure prepares a piezoelectric gel material with diversified use scenes, provides a theoretical basis for solving a problem that compatibility matching is relatively poor when a pure PZT material is used to cement concrete on a large scale, can be used in multiple fields such as novel intelligent roads, intelligent roadbeds and key structure real-time health monitoring, and provides a brand new thought for unique green, short-process, highly-added-value and large-scale utilization of difficult-to-treat titanium-containing blast furnace slag in China.

The titanium-containing blast furnace slag and the lead and zirconium oxides are subjected to high-temperature calcination, Ca at an A site of perovskite is forced to migrate to silicate to form a feldspar phase with a gelling activity, the metal oxides react with TiO₂ in the perovskite and diopside to generate PZT, that is a source of a piezoelectric phase.

A one-step method uses the titanium-containing blast furnace slag to prepare a piezoelectric gel composite material, which can be used as a supplement to a gel material while provides a piezoelectric phase in a cement-based piezoelectric composite material. However, the currently obtained composite material still has a large space for improving a piezoelectric coefficient. In the future, a dynamic behavior of a PZT phase formation will be studied, formation and composition of the PZT phase in the multi-component complex system will be precisely controlled, and thus a piezoelectric property of the material is enhanced.

(2) The present disclosure specifically provides components of a piezoelectric phase and a gel phase and a forming mechanism. Different from the prior art, a piezoelectric gel material can be blended into cement concrete, that is, can be used as a supplement of a gel active component, and can also be used correspondingly in the field of intelligent road traffic, such as structural health monitoring and the like.

(3) The present disclosure uses the titanium-containing blast furnace slag as an introduced titanium source to replace a pure reagent TiO₂ and calcium and siliceous substances in the titanium slag are converted and combined into a silicate with a gelling activity; the titanium slag system is complex and diversified, and the reaction is difficult to control. Through research and discussion of thermodynamic analysis, formation mechanism and reaction mechanism, a piezoelectric gel material is prepared by using the titanium-containing blast furnace slag as a titanium source by changing holding temperatures and time, and thus a purpose of comprehensive utilization of the titanium blast furnace slag as a resource is achieved. In the prior art, zirconium dioxide powder is selected as a filler to avoid volatilization of PbO. The PbO is uniformly mixed in the titanium slag system, the titanium slag acts as a reactant and a filler and the volatilization of the PbO is avoided to a greatest extent.

### BRIEF DESCRIPTION OF THE DRAWINGS

FIG. 1 is a thermodynamic curve diagram of relevant reaction in a modification and reconstruction process of the present disclosure;

FIG. 2 is a thermodynamic curve diagram in a modification and reconstruction process of the present disclosure;

FIG. 3 is a scanning electron microscope image of a sample obtained in example 1;

FIG. 4 is a scanning electron microscope image of a sample obtained in example 2;

FIG. 5 is a scanning electron microscope image of a sample obtained in example 3;

FIG. 6 is a scanning electron microscope image of a sample obtained in example 4;

FIG. 7 is an X-ray diffraction image of mineral-phase reconstruction under different calcination temperatures of the present disclosure;

FIG. 8 is a piezoelectric coefficient d₃₃ of a sample under different calcination temperatures in the present disclosure; and

FIG. 9 is a gel active component content of a sample under different calcination temperatures in the present disclosure.

### DETAILED DESCRIPTION OF THE PREFERRED EMBODIMENTS

The present disclosure is further described below with reference to specific examples.

Table 1 Modification and reconstruction process technological parameters in examples and a comparative examples

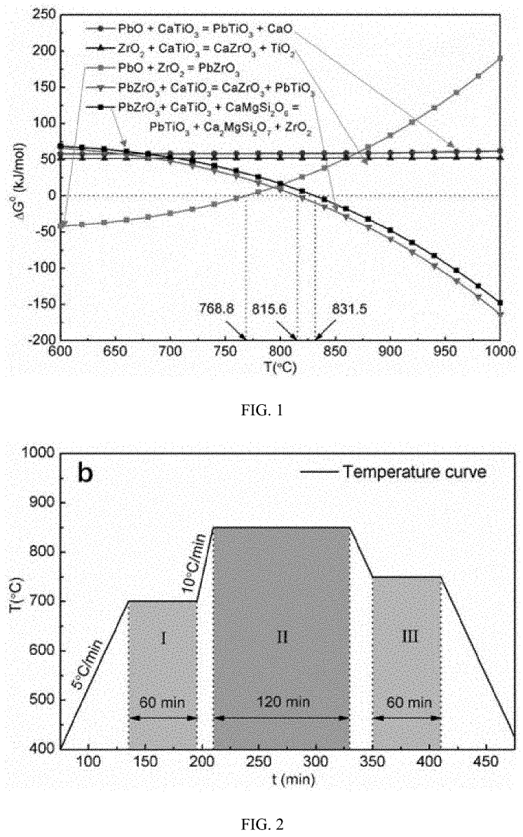

A titanium-containing blast furnace slag block was crushed and ground in a grinding tank for 60 s, after drying, 16.472 g of the ground material was weighed and mixed with 24.844 g of analytically pure lead oxide and 6.493 g of analytically pure zirconium dioxide, an obtained mixture was ground with an agate mortar for 30 min or more to ensure that the components were fully and uniformly mixed, and a muffle furnace is used as a heating device. In the first stage (heating stage), the mixed powder was heated to 700° C. at a heating rate of 5° C./min and heat preservation was conducted for 1 h; in the second stage, heating was conducted to 800-910° C. at a heating rate of 10° C./min and heat preservation was conducted for 2 h; and in the final stage, heat preservation was conducted at 750° C. for 1 h. After cooling to a room temperature with a furnace, a gel composite material sample with a piezoelectric property was obtained and the powder changed from gray to orange after calcination. A thermodynamic curve diagram of relevant reaction in a modification and reconstruction process was shown in FIG. 1 and a thermodynamic curve diagram in a modification and reconstruction process was shown in FIG. 2.

According to different temperatures in the second stage of the modification and reconstitution process, four examples and one comparative example were set as shown in Table 1.

Performance Tests

(1) EDS Energy Spectrum Analysis

Table 2 EDS energy spectrum analysis results (at %) of samples in each example

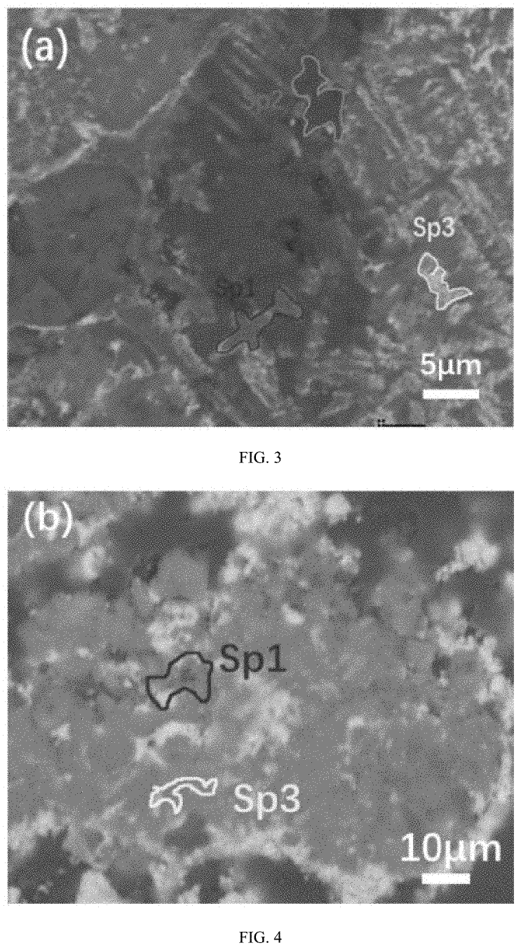

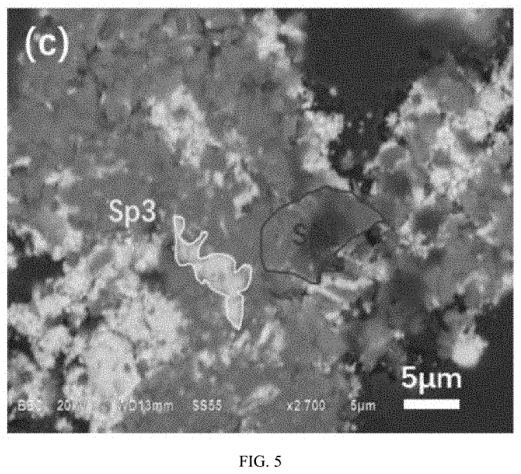

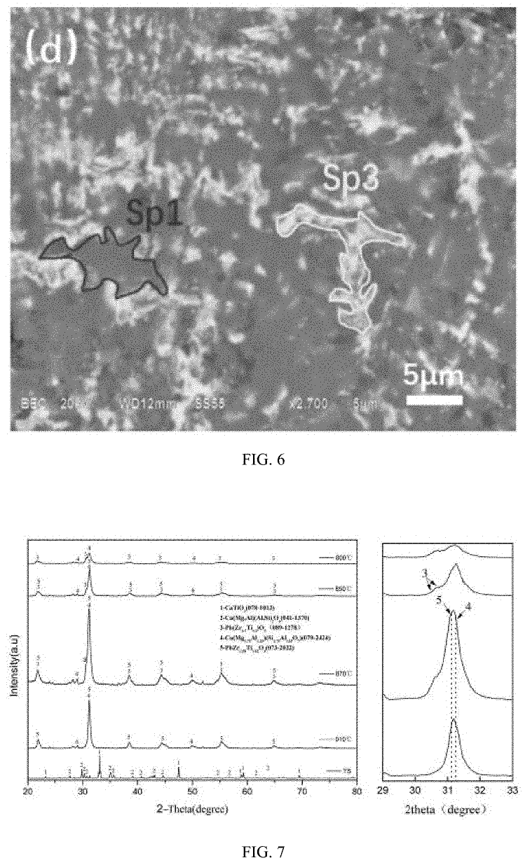

FIGS. 3-6 are scanning electron microscope images of the samples obtained in examples 1-4, respectively. It can be seen from FIG. 3 that there were three areas with different contrasts: gray area Sp1, black area Sp2, and gray white area Sp3. The black area in FIGS. 4-5 is an epoxy plane. Combined with an SEM-EDS energy pectrum analysis in Table 2: in FIG. 5, Sp1 presented a vein shape, main elements were Ca and Ti, and the atomic percentage content was 96.21%, which was a perovskite phase, and a small amount of Zr and Pb entered the mineral phase; main elements in Sp2 were Ca, Al, Mg and Si, and a small amount of a PZT phase was contained, that is, diopside in a titanium slag reacted with PbZrO₃ to generate PbTiO₃ and a feldspar phase; and Sp3 presented gray-white lines and was also in a process of transformation from the diopside phase to the feldspar phase, which reflected an initial stage of mineral-phase reconstruction. In FIG. 4, the Pb content in Sp1 reached 38.06% and Zr/Ti=1.406, such that a trigonal phase (zirconium-rich) PZT and a PZT phase with partially dissolved Ca existed in Sp1. The contents of Si and Al were both higher than 11%, such that a feldspar phase containing Pb also existed. In Sp3, Zr/Ti≈1, indicating a PZT phase at an MPB phase boundary. In FIG. 5, the Pb content in Sp3 was as high as 39.69%. The PZT phases in Sp1 and Sp3 both contained a zirconium-rich PZT phase and an MPB type PZT phase, and the feldspar phase in Sp1 wrapped the PZT phase. In FIG. 6, the volatilization of PbO led to a decrease in the Pb content, a titanium-rich PZT phase existed in Sp1, thus a zirconium-rich state was shifted to a titanium-rich state due to thermolability of PbZrO₃. Most of Sp1 and 3 belong to a Pb-containing silicate phase and a part of a PZT phase.

The ribbon and vein PZT phases were tightly wrapped by the feldspar phase, while the larger-sized and irregular PZT phases were mostly distributed in an outer layer of particles. Combined with the EDS analysis, it can be seen that the Zr content in an outer PZT phase was significantly higher than that in an inner PZT phase. The difference in composition of the PZT phase meant that a formation mechanism was not single: a titanium source came from perovskite and diopside, and reaction was conducted to generate zirconium-rich Pb(Zr_{0.7}Ti_{0.3})O₃, MPB-type PbZr_{0.58}Ti_{0.42}O₃ and (Pb, Ca)ZrₓTi₁₋xO3 (partially dissolved Ca).

(2) XRD Detection

The gel composite material obtained in examples 1-4 was tested. An X-ray diffraction pattern was shown in FIG. 7 (TS represented an untreated titanium-containing blast furnace slag). An XRD phase analysis showed that characteristic peaks of 3-Pb(Zr_{0.7}Ti_{0.3})O₃ and 4-Ca₂(Mg_{0.75}Al_{0.25})(Si_{1.75}Al_{0.25}O₇) appeared at 800° C., the zirconium-rich Pb(Zr_{0.7}Ti_{0.3})O₃ was gradually transformed into PbZr_{0.58}Ti_{0.42}O₃ with rise of a temperature, that is, transformation from a trigonal phase to a tetragonal phase occurred, such that a crystal structure was near an MPB phase boundary. After the mineral-phase reconstruction, Ca(Mg, Al)(Al, Si)₂O₆ in the titanium slag was transformed into Ca₂(Mg_{0.75}Al_{0.25})(Si_{1.75}Al_{0.25}O₇). At 910° C., intensity of characteristic peaks of PZT decreased since Pb was compounded with different silicates and the PZT content was reduced. With increase of temperatures, peak positions and peak shapes remained basically unchanged, but intensity of a diffraction peak gradually increased, the shape was symmetrical and sharp, and the peak gradually approached an MPB morphology phase boundary.

It can be seen from a partial enlarged view of the characteristic peak at 29-33° that as the temperature increased, the peak position near 2θ≈31° gradually shifted to the left. According to a Bragg formula: 2dsinθ=nλ, an interplanar spacing and a lattice constant increased, zirconium-rich Pb(Zr_{0.7}Ti_{0.3})O₃ gradually transformed into MPB-type PbZr_{0.58}Ti_{0.42}O₃, Zr⁴⁺ had a radius of 0.072 nm, Ti4+ had a radius of 0.0605 nm, and in Pb(Zr_{0.7}Ti_{0.3})O₃, the Zr⁴⁺ and the Ti⁴⁺ had average ionic radius of 0.06855 nm, after transformation, the average ionic radius was 0.06717 nm, such that a lattice constant and a lattice distortion increased, and a peak position shifted to a low angle. It can be seen from a right side of FIG. 7 that there was an asymmetric structure in a peak shape, indicating that there were multiple “contributions” to the peak, namely Pb(Zr_{0.7}Ti_{0.3})O₃ (trigonal phase), PbZr_{0.58}Ti_{0.42}O₃ (MPB) and Ca₂(Mg_{0.75}Al_{0.25})(Si_{1.75}Al_{0.25}O₇).

(3) Piezoelectric Property Detection

Piezoelectric effect: when subjected to a mechanical stress from a certain direction, electrical polarization occurred internally to generate a potential difference. A larger d₃₃ value indicated that more charges were generated inside, the electrical polarization was stronger and the potential difference was larger, which meant a better mutual coupling property between a mechanical stress and a dielectric property.

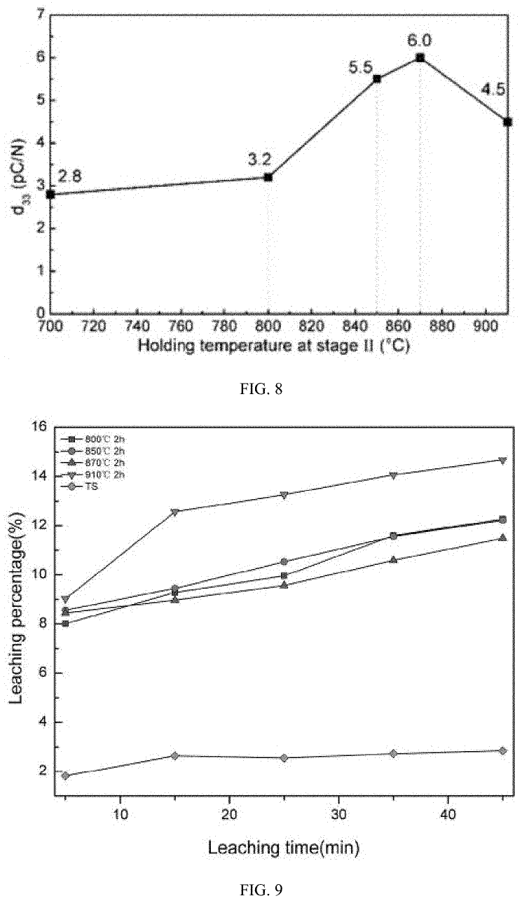

The piezoelectric coefficient d₃₃ of examples 1-4 was shown in FIG. 8. It can be concluded that d33 slightly increased in a range of 700-800° C., reached a maximum value of 6.0 pC/N at 870° C. during 800-870° C. and reduced to 4.5 pC/N at 910° C. It should be emphasized that a piezoelectric property of the second stage of the comparative example 1 was lower than that of the four examples when heat preservation was conducted at 700° C.

(4) Gel Activity Detection

The content of the gel active component was shown in FIG. 9. It can be concluded that with extension of leaching time, the leaching amount gradually increased, but a dissolution rate decreased. The leaching amount of a sample after heat preservation at 910° C. for 1 h was the largest and can reach 14.67%. The leaching amount of the titanium slag at different time points was maintained at a low standard, indicating that the hydration activity of the reconstructed and modified titanium slag had a high correlation with a leaching percentage, which effectively improved the hydration activity of a silicate in the original titanium slag. Titanium-containing diopside acted as a hydration inert phase and its participation in the hydration process resulted in a poor gel property of C-S-H (calcium silicate hydrate). After the mineral phase was reconstructed, the titanium-containing diopside was transformed into the feldspar phase, which had a good gelling activity. After the mineral-phase reconstruction, the structures of the perovskite and the diopside changed, which promoted the formation of the feldspar phase. The expression of the gel activity was closely related to a dissolution behavior of Ca²⁺, Si⁴⁺ and Al³⁺ in a water system and an EDTA-alkali solution can selectively dissolve a silicate phase and an aluminate phase. During the dissolution process, fine particles were continuously formed by breaking, wrapped silicate particles were continuously released, thus the contact with the EDTA-alkali solution was accelerated and a reaction rate was slightly faster in an early stage. The perovskite in the original titanium slag had poor reactivity and strong acid and alkali resistance, while the various mineral phases in the titanium slag were embedded and wrapped with each other, and difficult to dissociate and had low reactivity and a limited contact and reaction area with the EDTA-alkali solution. When an extreme small amount of the diopside reacted with the EDTA-alkali solution to form a chelate complex, the wrapped perovskite was released, such that the leaching percentage slowed down in a later stage and the leaching amount tended to be stable. It was indicated that the hydration activity of the silicate can be properly improved after mineral-phase modification and reconstruction.

Table 3 Proportion of gel phase in samples of each example

Item Example 1 Example 2 Example 3 Example 4 Mass percentage of gel phase/% 12.27 12.22 11.49 14.67

It should be noted that a product of comparative example 1 had basically no gel properties after searching under a low piezoelectric property.

In particular, it was measured that the piezoelectric phase of the samples in each example accounted for 50-60% of the total mass of the system.

(5) Dissolution Evaluation of Heavy Metals

Table 4 Dissolution amount of metal ions in samples prepared in each example/(mg/L)

Item Example 1 Example 2 Example 3 Example 4 Pb 0.29 0.23 0.26 0.35 Ti 0.22<0.02<0.02 0.12

According to the standard of CB 5083.3-2007, the content of lead element in the tertiary soil is ≤500 mg/kg and the leaching standard of a hazardous waste is ≤5 mg/L. It can be seen from Table 4 that the Pb leaching amount of the obtained PZT/titanium-containing blast furnace slag-based composite material under different conditions met the national safety standard.

In order to clarify leaching characteristics of Pb in the samples, the content of lead and titanium elements in the samples was measured as shown in Table 5 below:

Table 5 XRF (wt %) of samples prepared in each example

Item Example 1 Example 2 Example 3 Example 4 PbO 49.412 48.519 49.581 49.526 TiO₂ 6.581 6.643 6.541 6.425

It can be seen from Table 5 that each group of samples had a relatively high lead content whose mass percentage accounted for about 49% of the system. It can be concluded that the leaching amount of lead was not necessarily related with the content of lead, but was closely related with an endowed form, a texture structure and a leaching capacity of a PZT phase and a Pb-containing silicate phase in each group of samples.

It can be seen from Table 4 that the leaching amount of titanium ions was ≤0.22 mg/L. After a mineral-phase reconstruction of free TiO₂ in the titanium-containing blast furnace slag, the TiO₂ was endowed in the titanium slag system in a form of a PZT solid solution, a chemical property was relatively stable and only extremely weakly water solubility existed.

In the above examples, only different holding temperatures in the second stage are compared and other parameters such as the heating rate, the holding time and the cooling rate are all best embodiments. The product of the present disclosure can be prepared within the scope of the claims of the present disclosure, but a piezoelectric property and a gel property are not best. The examples listed in the present disclosure are only one of the embodiments of the present disclosure and do not limit the embodiments described in the present disclosure. As long as modifications or equivalent substitutions are made without departing from the spirit and principle of the present disclosure, the scope of the claims of the present disclosure shall be covered. For example, scopes of the reaction temperatures and the reaction time in each step of the present disclosure are reasonable and preferable. In fact, the reaction temperatures and the reaction time both have a broad scope and as long as the product of the present disclosure can be prepared, the values not in the scope of the present disclosure belong to one embodiment not mentioned in the present disclosure.

What is claimed is:

1. A method for preparing a gel composite material with a piezoelectric property, specifically comprising the following steps:
(1) crushing: crushing and grinding a titanium-containing blast furnace slag to powder;
(2) uniform mixing: uniformly mixing the powdery titanium-containing blast furnace slag obtained in step (1) with lead and zirconium oxides to obtain a multi-component system mixture; and
(3) modification and reconstruction: in a first stage, conducting heat preservation at 600° C.-768.8° C. for 0.5-1.5 h, in a second stage, accelerating heating to 800° C.-910° C. and conducting heat preservation for 1.5-2.5 h, in a third stage, cooling to 700° C.-768° C. and conducting heat preservation for 1.0-2.5 h, and cooling to a room temperature with a furnace to obtain a gel composite material containing a piezoelectric phase and a gel phase;
wherein, the piezoelectric phase is PbZrₓ Ti₁₋ₓO₃ (0<x<1), and the gel phase is Ca2MgSi2O7.

2. The method for preparing a gel composite material with a piezoelectric property according to claim 1, wherein in step (2), three elements Pb, Zr and Ti of the multi-component system mixture have a molar ratio of Pb:Zr:Ti at 1.1:0.52:0.48.

3. The method for preparing a gel composite material with a piezoelectric property according to claim 2, wherein in step (2), the lead and zirconium oxides are PbO and ZrO₂ separately.

4. The method for preparing a gel composite material with a piezoelectric property according to claim 1, wherein the titanium-containing blast furnace slag has a mass percentage of TiO2 larger than 20%.

5. The method for preparing a gel composite material with a piezoelectric property according to claim 1, comprising the following steps: in step (3), in a first stage, conducting heat preservation at 700° C. for 1 h, in a second stage, accelerating heating to 800° C.-910° C. and conducting heat preservation for 2 h, in a third stage, cooling to 750° C. and conducting heat preservation for 1 h, and cooling to a room temperature with a furnace to obtain a gel composite material containing a piezoelectric phase and a gel phase.

6. The method for preparing a gel composite material with a piezoelectric property according to claim 5, wherein a heating rate of the first stage is 5-10° C./min, a heating rate of the second stage is larger than or equal to 10° C./min, and a cooling rate of the third stage is 5-10° C./min.

7. A gel composite material with a piezoelectric property obtained by method of claim 1, wherein the gel composite material contains a piezoelectric phase and a gel phase, wherein the piezoelectric phase is PbZrₓTi₁₋ₓO₃ (0<x<1) and accounts for 50-60% of a total mass of a system, and the gel phase is Ca₂MgSi₂O₇ and accounts for 8-15% of the total mass of the system.

8. The gel composite material with a piezoelectric property according to claim 7, wherein in step (2) of the method, three elements Pb, Zr and Ti of the multi-component system mixture have a molar ratio of Pb:Zr:Ti at 1.1:0.52:0.48.

9. The gel composite material with a piezoelectric property according to claim 7, wherein in step (2) of the method, the lead and zirconium oxides are PbO and ZrO2 separately.

10. The gel composite material with a piezoelectric property according to claim 7, wherein the titanium-containing blast furnace slag has a mass percentage of TiO2 larger than 20%.

11. The gel composite material with a piezoelectric property according to claim 7, wherein in step (3) of the method, in a first stage, conducting heat preservation at 700° C. for 1 h, in a second stage, accelerating heating to 800° C.-910° C. and conducting heat preservation for 2 h, in a third stage, cooling to 750° C. and conducting heat preservation for 1 h, and cooling to a room temperature with a furnace to obtain a gel composite material containing a piezoelectric phase and a gel phase.

12. The gel composite material with a piezoelectric property according to claim 7, wherein a heating rate of the first stage is 5-10° C./min, a heating rate of the second stage is larger than or equal to 10° C./min, and a cooling rate of the third stage is 5-10° C./min.

13. A cement concrete, wherein the cement concrete comprises the gel composite material with a piezoelectric property according to claims 7.
